(19) United States
(12) Patent Application Publication
(10) Pub. No.: US 2011/0306012 A1
(43) Pub. Date: Dec. 15, 2011

(54) TOOL FOR THE TREATMENT OF SURFACES OF DENTAL MATERIALS

(76) Inventor: Günter SMAILUS, Agra (CH)

(21) Appl. No.: 13/156,712

(22) Filed: Jun. 9, 2011

(30) Foreign Application Priority Data
Jun. 11, 2010 (EP) 10405114.09

(51) Int. Cl. A61C 3/00

(52) U.S. Cl. 433/142

(57) ABSTRACT

The tool for the treatment of surfaces of dental materials with liquids, includes an abrasive body that includes a carrier material and abrasive particles embedded therein. In order to achieve a vibration-free treatment of said dental surface the carrier material is cellulose-based and the cellulose-based material is prepared in such a way as to possess a capacity for absorbing liquids for softening the carrier material.

### BACKGROUND OF THE INVENTION

The present invention pertains to a tool for the treatment of surfaces of dental materials with liquids, with an abrasive body that comprises a carrier material and abrasive particles embedded therein.

Such prior art dental brushes are produced according to state of the art technology, disclosed in many patents and leaflets, for example in U.S. Pat. No. 6,312,257 B1, EP 1 384 418 B1 or dental polishing tools in EP 0 972 495 A1. The material of the abrasive body consists of synthetic material, silicones, fiber reinforced synthetic materials, metals and other appropriate materials. The principle of working of such abrasive bodies relies on a solid anchorage of the abrasive particles in the support that is abraded at the surface to be treated, whereby the abrasive particles are freed subsequently and become active.

The filling mass causes a hardening of the support materials. This leads, when working on a synthetic or natural dental surface, to high rotational vibrations, which are highly disagreeable for the patient and the dentist. Furthermore, the results are only obtained proportional to the time of treatment and to the abrasion of the support material and thus not optimal.

For example with state of the art brushes with bristles made of Kevlar and Nylon, the Kevlar bristles are filled with diamond particles and the Nylon bristles with aluminum oxide. Treatment is thus performed according to the functional principles described above, with the abrasive particles being released through wear of the bristles. For more solid or even-shaped polishers, as a rule a silicone mass is used in which diamond particles are embedded and which operate according to the same principle, i.e. also through the successive release of abrasive particles.

### SUMMARY OF THE INVENTION

It is the object of the present invention, based on the known prior art, to provide tools for the treatment of dental surfaces which, on the one hand, ensure trouble-free, in particular vibration-free work using an electrically driven handpiece and on the other hand achieve greater treatment efficiency. This object is attained with the a tool wherein the carrier material is cellulose-based and the cellulose-based material is prepared in such a way as to possess a capacity for absorbing humidity for softening the carrier material. Further advantages and embodiments are described in the dependent claims.

### DETAILED DESCRIPTION OF THE INVENTION

The invention will be explained hereinafter. The solution to the above stated object involves using a carrier material based on a liquid absorbing cellulose material.

Dental tool using cellulose based material are known, f. ex. from U.S. Pat. No. 1,138,479 A which discloses a dental polishing device comprising two celluloid layers having flexibility, resilience and strength or toughness, however no capacity to be softened by a liquid.

US 2009/0042166 A1 discloses an abrasive tool comprising a wealth of embedding materials being all elastomers with no or very reduced capacity to absorb a liquid. The same applies to the tool according to French FR-985 442 disclosing a cutting-off wheel made of Ebonite. Swiss patent No. 699 819 to the same applicant discloses a support made of cellulose acetate, which is not liquid absorbing but has been chosen for its flexibility.

US 2001/038914 A1 discloses a method of manufacturing a textured toothbrush bristle, the texture comprising an active ingredient like therapeutic agents, or whitening or abrasive agents and including, among many others, carboxymethyl cellulose and hydroxyethyl cellulose. Finally, WO-2010/060653 A2 discloses a dental care product with diamond particles that are bonded by a water soluble binder, whereby that binder can comprise also cellulose or modified cellulose or cellulose derivates.

In a brochure published by the Swiss company smartfiber AG, the production of functional materials based on cellulose is explained, suggesting as areas of application polishing brushes for hard metal and sapphire machining, and grinding bristles for deburring. The publication hereby emphasizes that problems with softening and/or lubrication must be avoided.

Experiments with similar cellulose filaments and layers have surprisingly revealed that, in contrast to the proposed industrial uses where all softening should be avoided, it is precisely the capacity to absorb liquids, in general water, which is a crucial advantage in the surface treatment of dental materials. This is particularly important because virtually all treatments of dental surfaces, i.e. of natural or artificial teeth, are carried out with water flushing.

A special ability of cellulose fibers is the absorption of a relatively large amount of moisture, and it has come as a surprising revelation that cellulose-based filaments, for example, are very efficient for the treatment of dental surfaces when moist. One reason is that numerous abrasive particles, such as diamond particles, are released when the cellulose swells and can unfold their full effectiveness from the very start.

The absorption of water causes the already naturally soft cellulose to change into a “super-soft” consistency, which, when used as a brush with diamond-filled filaments, enables both pre-polishing and final polishing. The rotational vibrations when using an electrically handpiece are not noticeable here. In addition, the result, e.g. gloss and roughness during polishing, is significantly improved.

As already mentioned, the new cellulose-based carrier material, especially in the form of filaments which are bundled into small brushes, is suitable for polishing dental materials such as composite or ceramics of all types, as well as natural teeth. There are also other applications for this cellulose-based material, on surface substrates such as plastics or paper of all kinds, in the form of strips, discs, files, etc., in all sizes. In addition, the cellulose material can also be applied to round rotatable carriers.

In addition to the abrasive particles, active and passive agents such as silver ions, zinc, fluorides, ceramic or carbons can be added to the abrasive body in order to have an antibacterial effect (silver ions, zinc), provide additional protection against caries (fluoride) and increase the filaments' resistance (ceramics, carbons).

What is claimed is:

1. A tool for the treatment of surfaces of dental materials with liquids, with an abrasive body that comprises a carrier material and abrasive particles embedded therein, wherein the carrier material is cellulose-based and the cellulose-based material is prepared in such a way as to possess a capacity for absorbing humidity for softening the carrier material.

2. A tool according to claim 1, wherein the cellulose-based carrier material forms the bristles of a dental brush, with the abrasive particles embedded inside.

3. A tool according to claim 1, wherein the abrasive body with the cellulose-based carrier material is applied to substrate surfaces such as plastics or paper of all kinds in the form of strips, discs, files.

4. A tool according to claim 1, wherein the abrasive body with the cellulose-based carrier material is applied to rotatable substrata.

5. A tool according to claim 4, wherein the abrasive body is applied to a core, the form of which is similar to the surface of the tool.

6. A tool according to claim 1, wherein active and passive agents, such as silver ions, zinc, fluorides, ceramic or carbon, are admixed to the abrasive body.
